(19) United States
(12) Patent Application Publication
(10) Pub. No.: US 2016/0086224 A1
(43) Pub. Date: Mar. 24, 2016

(54) SYSTEM FOR CONTEXTUALIZING MAP SELECTIONS

(71) Applicant: Google Inc., (US)

(72) Inventors: Arnold Binas, Kirribilli (AU); Jordan Bayliss-McCulloch, Beaconsfield (AU); Alexander Berry, Chippendale (AU); Robert J. Bowmaker, Balmain (AU)

(73) Assignee: Google Inc., Mountain view, CA (US)

(21) Appl. No.: 13/708,865

(22) Filed: Dec. 7, 2012

(51) Int. Cl. G06Q 30/02

(52) U.S. Cl. CPC G06Q 30/0256

(57) ABSTRACT

A system for contextualizing map selections may include one or more processors and a memory. The one or more processors may provide for display a map comprising a plurality of objects related to a query associated with a user. The one or more processors may receive a selection of one of the plurality of objects of the map. The one or more processors may retrieve an advertising content item based at least in part on the received selection of the one of the plurality of objects and the query.

### TECHNICAL FIELD

The present description relates generally to map selections, and more particularly, but not exclusively, to contextualizing map selections.

### BACKGROUND

In online advertising systems, advertising content items, such as offers, coupons, and/or advertisements, are presented to users on web pages, such as on geographical map pages. If a user clicks on an advertising content item on a web page, and/or performs some other action subsequent to clicking on an advertising content item, the operator of the web page may be compensated, such as by the entity or business associated with the advertising content item. In some instances, the likelihood of a user clicking on an advertising content item may be directly correlated to the relevance that the advertising content item has to the user, such as the relevance of the advertising content item to a map being viewed by the user, and/or the relevance of the advertising content item to an object on the map that is selected by the user. Thus, it may be desirable for web page operators, such as geographical map providers, to present advertising content items to users that have relevance to the users, such as advertising content items that are relevant to the maps being viewed by the users and/or to objects presented on the maps that are selected by the users, in order to increase the likelihood that the users will click on one of the presented advertising content items.

### SUMMARY

The disclosed subject matter relates to a computer implemented method for contextualizing map selections. The method may include receiving, using one or more computing devices, a query associated with a user. The method may further include providing for display, using the one or more computing devices and in response to the receiving, a map comprising a plurality of objects related to the query. The method may further include receiving, using the one or more computing devices, a selection of one of the plurality of objects of the map. The method may further include retrieving, using the one or more computing devices, an advertising content item based at least in part on the one of the plurality of objects and the query.

In another aspect, the computer implemented method may include receiving, using one or more computing devices, a query associated with a user. The method may further include providing for display, using the one or more computing devices and in response to the receiving, a map comprising a plurality of objects related to the query, wherein the plurality of objects are associated with a plurality of businesses. The method may further include receiving, using the one or more computing devices, a selection of one of the plurality of objects of the map. The method may further include providing, using the one or more computing devices and to an advertising content retrieval system, the query and at least a portion of information corresponding to the one of the plurality of businesses that is associated with the selected one of the plurality of objects. The method may further include receiving, using the one or more computing devices, an advertising content item from the advertising content retrieval system. The method may further include providing for display, using the one or more computing devices, the advertising content item and the information corresponding to the one of the plurality of businesses to a device of the user, wherein the advertising content item is distinct from the information.

The disclosed subject matter also relates to a system for contextualizing map selections. The system may include one or more processors and a memory including instructions that, when executed by the one or more processors, cause the one or more processors to: provide for display a map comprising a plurality of objects related to a query associated with a user, receive a selection of one of the plurality of objects of the map, and retrieve an advertising content item based at least in part on the received selection of the one of the plurality of objects and the query.

The disclosed subject matter also relates to a non-transitory machine-readable medium embodying instructions that, when executed by a machine, allow the machine to perform a method for contextualizing map selections. The method may include providing a search query corresponding to a map. The method may further include receiving for display a plurality of objects on the map based at least in part on the search query, and providing a selection of one of the plurality of objects on the map. The method may further include receiving for display information related to the one of the plurality of objects on the map and receiving an advertising content item that is selected based at least in part on the query and at least a portion of the information.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement a system for contextualizing map selections in accordance with one or more implementations.

FIG. 2 illustrates a flow diagram of an example process for a system for contextualizing map selections in accordance with one or more implementations.

FIG. 3 illustrates a flow diagram of an example process for a system for contextualizing map selections in accordance with one or more implementations.

FIG. 4 illustrates an example map interface for a system for contextualizing map selections in accordance with one or more implementations.

FIG. 5 illustrates an example map interface for a system for contextualizing map selections in accordance with one or more implementations.

FIG. 6 conceptually illustrates an electronic system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In some instances, structures and components are shown in block diagram form in order to avoid obscuring the concepts of the subject technology.

I. Overview

In the subject system for contextualizing map selections, a query associated with a user viewing a map may be received and, in response thereto, one or more objects may be presented on the map to the user. In one or more implementations, the objects on the map may be associated with businesses that are related to the query. Alternatively, or in addition, the map may also include one or more advertising content items that are related to the query. The user may select one of the objects on the map, such as to view information that pertains to the business that is associated with the object, and, in response thereto, the system may retrieve an advertising content item, such as an offer, a coupon, or an advertisement, based at least in part on the query and at least a portion of the information that pertains to the business that is associated with the object. In one or more implementations, at least the portion of the information that pertains to the business may include a name of the business, a category associated with the business, a keyword associated with the business, or generally any information that pertains to the business. In one or more implementations, the system may retrieve the advertising content item by providing the query, and at least the portion of the information that pertains to the business, such as the name of the business, to an advertising content retrieval system. The advertising content retrieval system may return an advertising content item that is then provided to the user.

The phrase “advertising content item” as used herein encompasses its plain and ordinary meaning and, if not otherwise included in its plain and ordinary meaning, may also refer to any information that may be presented to a user to promote a business, such as a coupon, an advertisement, or an offer, e.g. a pre-paid offer or voucher.

In one or more implementations, the system may provide the advertising content item to the user at least partially contemporaneous to providing the information that pertains to the business that is associated with the object selected by the user. For example, the advertising content item and the information that pertains to the business may be overlaid on the map being viewed by the user. Since the advertising content item provided to the user is retrieved based at least in part on both the query and at least the portion of the information that pertains to the business, such as the business name, there may be a higher likelihood that the provided advertising content item will have relevance to the user than if the advertising content item had been retrieved based solely on at least the portion of the information that pertains to the business.

For example, a user who is viewing a map may submit a query for “pizza” and, in response thereto, the map may be populated with graphical objects associated with businesses that are related to pizza. In one or more implementations, the graphical objects may be populated on the map in areas that coincide with where the associated businesses are physically located. However, in one or more instances the names of the businesses, e.g. “Luigi's Italian,” “Del Piero's,” etc., may not necessarily include the query, e.g. “pizza.” If the user selects a graphical object associated with a business, the system may retrieve advertising content items that are presented to the user along with information related to the business. If the presented advertising content items are selected based solely on information related to the business that does not include the query, e.g. the business name, the advertising content items may not accurately reflect the user's intent in viewing the map, e.g. searching for pizza in a geographic area. For example, if the name of a selected pizza restaurant is “Del Piero's,” the user may be presented with advertising content items that are generally relevant to, e.g., “Del Piero's,” “Del,” and/or “Piero,” but that are not necessarily relevant to pizza. As such, there may be a low likelihood that the presented advertising content items will have relevance to the user outside of the business they are already viewing. Therefore there may be a low likelihood that the user will click on one of the presented advertising content items. However, if the advertising content items are retrieved based at least in part on both the name of the business, e.g. “Del Piero's,” and the query, e.g. “pizza,” then the user may be presented with advertising content items that may be relevant to, e.g., “Del Piero's” and/or “pizza,” such as other pizza restaurants. As such, there may be a high likelihood that the presented advertising content items will have relevance to the user outside of the business that they are already viewing, and therefore a high likelihood that the user will click on one of the presented advertising content items.

In one or more implementations, in addition to providing the advertising content item with the information that is related to the business, the system may also populate the map with one or more additional advertising content items that are retrieved based at least in part on the query and at least the portion of the information that pertains to the business. Alternatively, or in addition, the system may merge advertising content items that are retrieved based solely on the query with advertising content items that are retrieved based solely on the information pertaining to the business, such as the business name. The additional advertising content items may be populated on the map in areas that coincide with the geographical locations of the businesses that are advertised by the additional advertising content items. The system may replace any existing advertising content items on the map with the additional advertising content items, and/or the system may supplement any existing advertising content items on the map with the additional advertising content items.

For explanatory purposes, queries are generally discussed herein in the context of search queries received from users that are associated with a map. However, a query may also refer to information that may be generated based on a user's interaction with an interface, such as a web page or a map interface. For example, if a user changes the geographic area displayed by a map, a query may be generated that reflects the changed geographic area. In another example, if a user clicks on an object on a map, such as a graphical object, a query may be generated based on information related to the object. Other queries may be generated based on other user interactions with an interface, such as a web page or a map interface.

II. Example Network Environments for a System for Contextualizing Map Selections

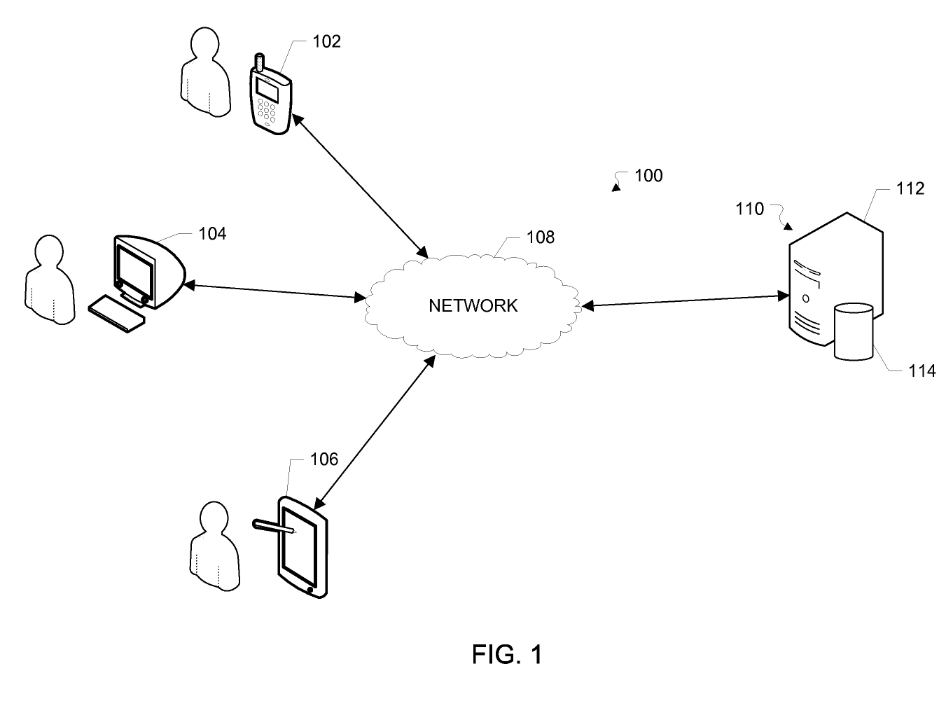

FIG. 1 illustrates an example network environment 100 which may implement a system for contextualizing map selections in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The network environment 100 may include a number of electronic devices 102, 104, 106 communicably connected to a server 110, such as by the network 108. In another example, some or all of the electronic devices 102, 104, 106 may be communicably connected to one another, such as by the network 108, and some or all of the electronic devices 102, 104, 106 may not be communicably connected to the server 110. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

In some example embodiments, the electronic devices 102, 104 and 106 can be computing devices such as laptop or desktop computers, smartphones, personal digital assistants (“PDAs”), portable media players, tablet computers, televisions or other displays with one or more processors coupled thereto and/or embedded therein, or other appropriate computing devices that can be used to for displaying a web page or web application. In the example of FIG. 1, the electronic device 102 is depicted as a smartphone, the electronic device 104 is depicted as a desktop computer, and the electronic device 106 is depicted as a tablet device.

In one example, server 110 may be a single computing device such as a computer server. In another example, server 110 may represent one or more computing devices (such as a cloud of computers and/or a distributed system) that are communicatively coupled, such as communicatively coupled over the network 108, that collectively, or individually, perform one or more functions that can be performed server-side, such as search result retrieval, advertising content retrieval, advertising content serving, and/or generally any functions that can be performed server-side. The one or more computing devices of the server 110 may be geographically collocated and/or the one or more computing devices of the server 110 may be disparately located. The server 110 may be coupled with various databases, storage services, or other computing devices. The server 110, and the coupled databases, storage services, or other computing devices may be geographically collocated, or may be disparately located.

In one or more implementations, the server 110 includes a processing device 112 and a data store 114. The processing device 112 executes computer instructions stored in the data store 114, for example, to contextualize map selections received from one or more of the electronic devices 102, 104, 106. In one or more examples, the data store 114 may store the computer instructions on non-transitory computer-readable medium.

The server 110 may host a web server that is communicatively coupled to client devices, such as web browsers of client devices (e.g., electronic devices 102, 104 or 106) via network 108. In one example, the subject system may be integrated into one or more of a search engine, a map engine, an advertising content retrieval system and/or an advertising content serving system hosted at server 110. In another example, the subject system may be hosted at server 110 and may be communicatively coupled to one or more remote servers hosting one or more other search engines, map engines, advertising content retrieval systems and/or advertising content serving systems (e.g., one or more remote servers) over one or more networks (e.g., network 108).

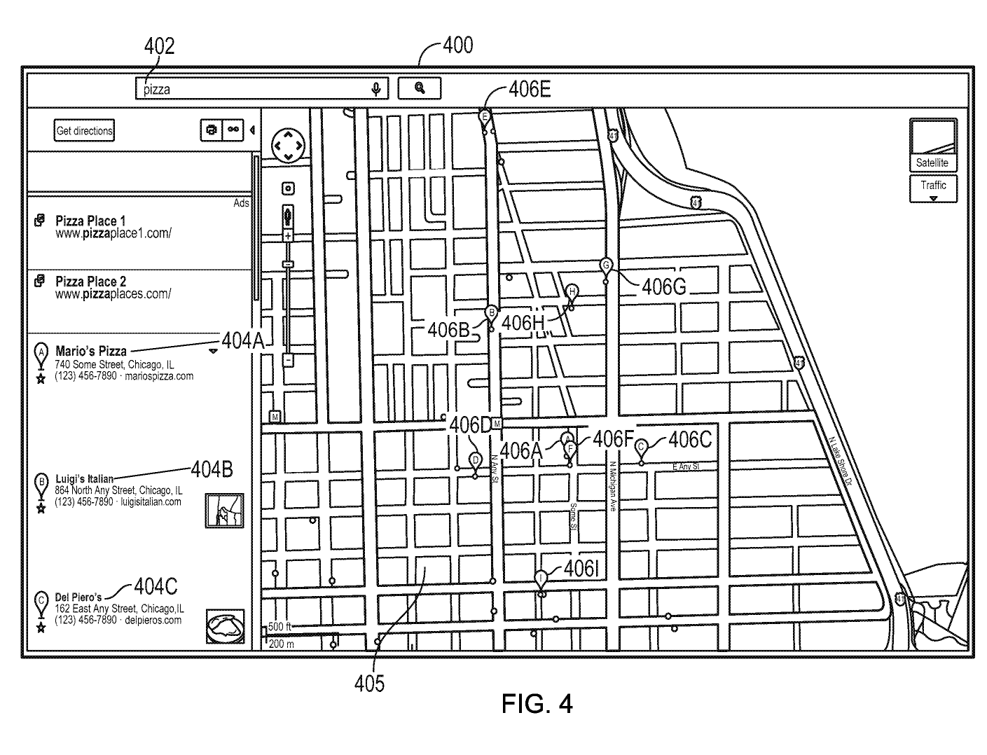

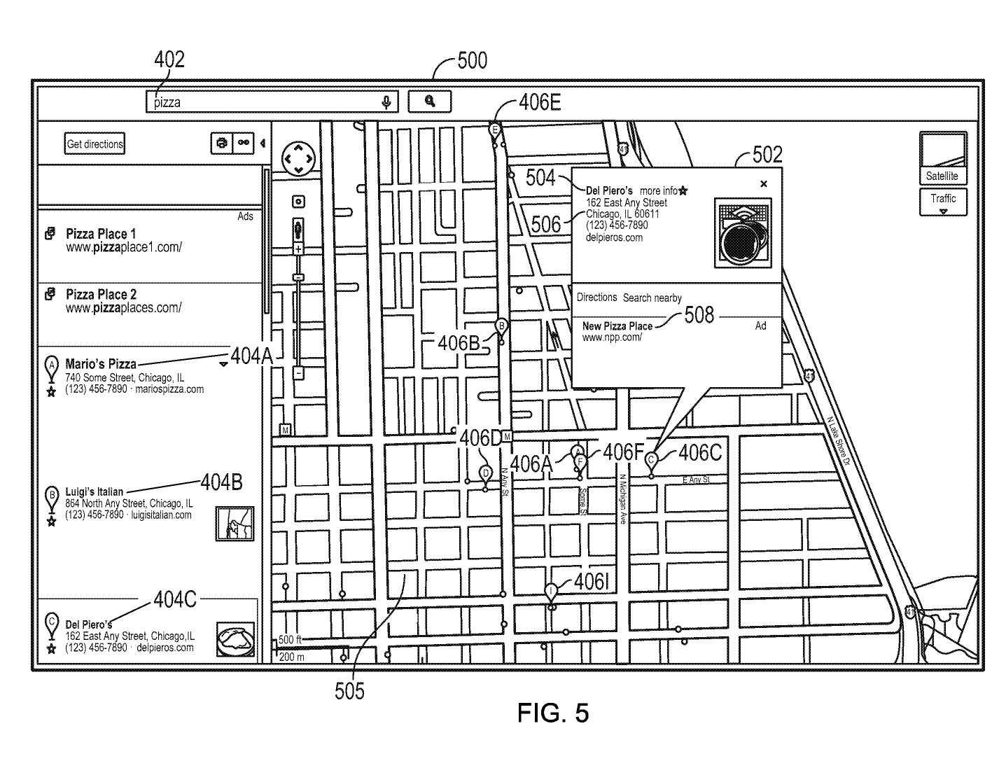

In operation, the server 110 may provide a map to one of the electronic devices 102, 104, 106, such as the electronic device 102, for display to a user. Example maps are illustrated in FIGS. 4 and 5 and are discussed further below with respect thereto. A user may view the map on the electronic device 102 and the user may input a query to the electronic device 102, such as in order to receive additional information on the map. The electronic device 102 may communicate the query to the server 110, such as over the network 108. In response to the query, the server 110 may provide one or more objects, such as advertising content items and non-advertising content items, to the electronic device 102 for display on the map to the user. The one or more objects may be associated with businesses that are related to the query.

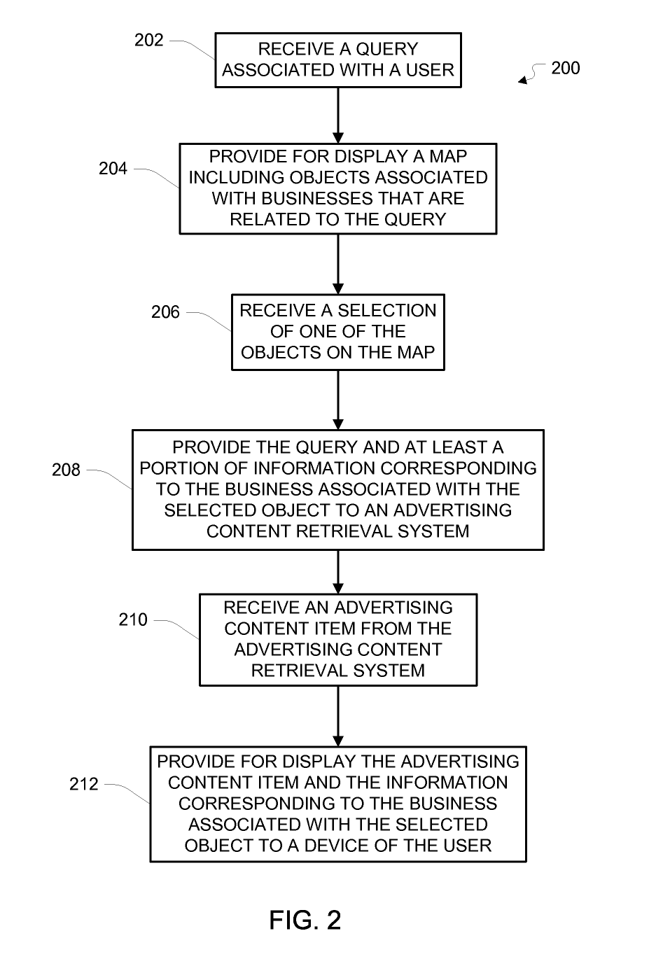

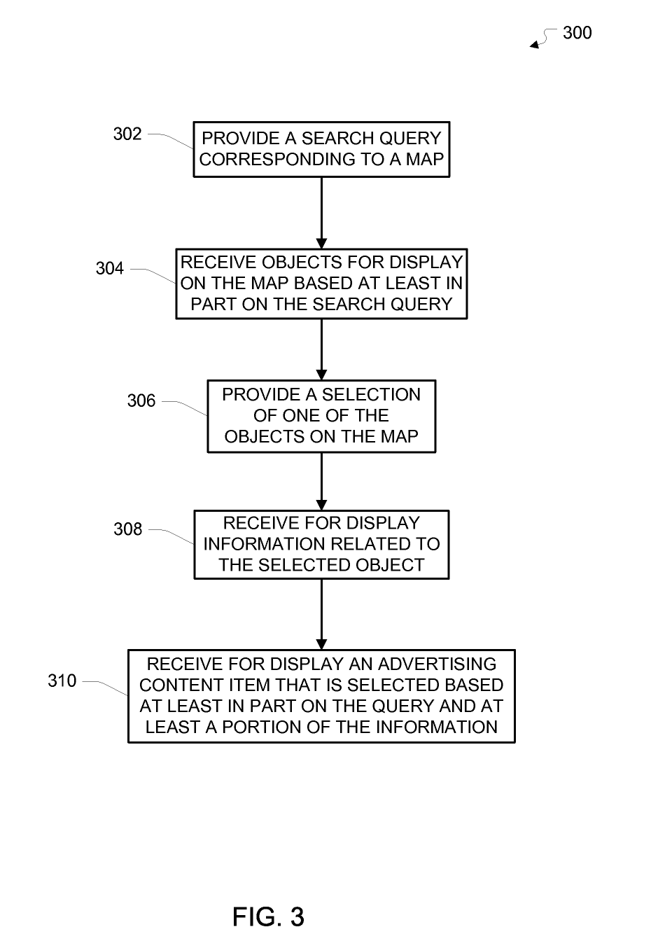

The user may select one of the objects on the map, such as to receive additional information regarding the business associated with the object, and, in response thereto, the server 110 may retrieve an advertising content item, such as an offer, a coupon, or an advertisement, based at least in part on the query and at least a portion of the information that pertains to the business that is associated with the object, such as the name of the business. The server 110 may provide the information that pertains to the business and the advertising content item to the electronic device 102 for display on the map to the user. In one or more implementations, at least the portion of the information that pertains to the business may include a name of the business, a category associated with the business, a keyword associated with the business, or generally any information that pertains to the business. Example processes of contextualizing a selection of an object on a map by a user are discussed further below with respect to FIGS. 2 and 3.

III. Example Processes for a System for Contextualizing Map Selections

FIG. 2 illustrates a flow diagram of example process 200 for contextualizing map selections in accordance with one or more implementations. For explanatory purposes, example process 200 is described herein with reference to example network environment 100 of FIG. 1; however, example process 200 is not limited to example network environment 100 of FIG. 1. Further for explanatory purposes, the blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

In block 202, the server 110 receives a query associated with a user. For example, the user may be accessing a map interface on the electronic device 102, such as the map interface illustrated in FIG. 4, and the first query associated with the user may be a search query provided by the user interacting with the electronic device 102. In block 204, the server 110 may provide for display a map to the electronic device 102 that includes objects associated with businesses that are related to the query. The electronic device 102 may display the map and the included objects to the user, such as via the map interface illustrated in FIG. 5. For example, the server 110 may determine a geographic area associated with the query, such as the geographic area presently being viewed by the user via the map interface, or a geographic area that is determinable from the query provided by the user. The server 110 may then search for businesses within the determined geographic area that are related to the query. The server 110 may provide for display a map to the electronic device 102 that encompasses the determined geographic area and that includes one or more graphical objects that are representative of the businesses within the geographic area that are related to the query. The electronic device 102 may present the map to the user, such as via the map interface.

In block 206, the server 110 may receive a selection of one of the graphical objects displayed on the map. For example, a user interacting with the electronic device 102 may select one of the graphical objects displayed on the map and the electronic device 102 may communicate the selection to the server 110, such as via the network 108. In block 208, the server 110 may provide the query and at least a portion of information corresponding to the business associated with the selected object to an advertising content retrieval system. The information corresponding to the business may include a name of the business, a category associated with the business, a keyword associated with the business, or generally any information that pertains to the business.

In block 210, the server 110 may receive an advertising content item, such as an offer, a coupon, or an advertisement, from the advertising content retrieval system. In block 212, the server 110 may provide for display the advertising content item and the information corresponding to the business associated with the selected object to the electronic device 102. The electronic device 102 may display the advertising content item and the information corresponding to the business associated with the selected object to the user, such as via an overlay on the map as illustrated in FIG. 5.

FIG. 3 illustrates a flow diagram of example process 300 for contextualizing map selections in accordance with one or more implementations. For explanatory purposes, example process 300 is described herein with reference to example network environment 100 of FIG. 1; however, example process 300 is not limited to example network environment 100 of FIG. 1. Further for explanatory purposes, the blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

In block 302, the electronic device 102 provides a search query corresponding to a map to the server 110, such as via the network 108. For example, the electronic device 102 may display a map interface to a user, such as the map interface illustrated in FIG. 4, and the user may input a search query by interacting with the electronic device 102. In block 304, the electronic device 102 may receive objects for display on the map from the server 110 based at least in part on the search query. The objects may be associated with businesses related to the search query. For example, the server 110 may determine the geographic area displayed on the map and/or a geographic area associated with the search query, and the server 110 may retrieve one or more businesses that are located within the geographic area and are related to the search query.

In block 306, the electronic device 102 may provide a selection of one of the objects on the map to the server 110, such as via the network 108. For example, a user interacting with the electronic device 102 may select one of the objects, such as by clicking on the object, touching the object, or generally any other manner of selecting an object on a map. In response to the user's selection, the electronic device 102 may communicate the selection to the server 110.

In block 308, the electronic device 102 may receive for display information related to the selected object from the server 110. The information may be related to the business associated with the selected object, such as the name of the business, a telephone number of the business, an address of the business, reviews of the business, or generally any information related to the business. In block 310, the electronic device 102 may receive for display an advertising content item that is selected by the server 110 based at least in part on the query and at least a portion of the information. For example, the server 110 may provide the query and the name of the business to an advertising content retrieval system and the advertising content retrieval system may select the advertising content item based at least in part on the query and the name of the business.

The electronic device 102 may display the information related to the selected object and the advertising content item on the map to the user. For example, the information related to the selected object and the advertising content item may be displayed in an overlay on top of the map, such as is illustrated in FIG. 5.

IV. Example Map Interfaces for Systems for Contextualizing Map Selections

FIG. 4 illustrates an example map interface 400 for a system for contextualizing map selections in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The map interface 400 may include a search query field 402, search results 404A-C, and a map 405. The map 405 may include objects 406A-I that correspond to the search results 404A-C. The map interface 400 may be displayed to a user via any of the electronic devices 102, 104, 106, such as the electronic device 102.

In operation, a user interacting with the electronic device 102 may input a search query into the search query field 402. The electronic device 102 may provide the search query to the server 110, such as via the network 108. The server 110 may retrieve the search results 404A-C based on the query and may provide the search results 404A-C to the electronic device 102 for display to the user. For example, the search results 404A-C may correspond to businesses that are located within the geographic area displayed on the map 405 that are related to the query inputted into the search query field 402. The electronic device 102 may display the search results 404A-C next to the map 405 and may display the objects 406A-I corresponding to the search results 404A-C on the map 405. For example, the objects 406A-I may be displayed on the map 405 at the geographic locations where the associated businesses are located. Although the map interface 400 only displays three search results 404-C there may be an equal number of search results 404A-C as there are objects 406A-I displayed on the map 405. The user may be able to view additional search results by scrolling through the search results 404A-C.

FIG. 5 illustrates an example map interface 500 for a system for contextualizing map selections in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The map interface 500 may include a search query field 402, search results 404A-C, and a map 505. The map 505 may include objects 406A-I that correspond to the search results 404A-C and a business information display area 502 that is overlaid onto the map 505. The business information display area 502 may include business information 506, such as a business name 504, and an advertising content item 508. The map interface 500 may be displayed to a user via any of the electronic devices 102, 104, 106, such as the electronic device 102.

In operation, the map 505 may be displayed to a user when the user selects one of the objects 406A-I displayed on the map 405 of FIG. 4. For example, a user viewing the map 405 of FIG. 4 via electronic device 102, may interact with the electronic device 102 to select one of the objects 406A-I displayed on the map 405, such as the object 406C. The electronic device 102 may communicate the user's selection to the server 110, such as via the network 108. The server 110 may retrieve the business information 506 for the business that is associated with the selected object 406C. The server 110 may then retrieve an advertising content item based at least in part on the search query entered into the search query field 402 and at least a portion of the business information 506, such as the business name 504. The server 110 may provide the map 505 that displays that business information display area 502 that includes the business information 506 in addition to the advertising content item 508. The advertising content item 508 may be advertising content related to the business associated with the selected object 406C, or may be advertising content related to any other business.

In the example of FIG. 5, the business information 506 corresponding to the selected object 406C includes a business name 504 of “Del Piero's,” which does not include the query entered into the search query field 402 (“pizza”). However, since the server 110 selects the advertising content item 508 based on the business name 504 (“Del Piero's”) and the query entered into the search query field 402 (“pizza”), the advertising content item 508 (“New Pizza Place”) relates to the user's intent in viewing the map 505, e.g. searching for pizza in a geographic area. If the server 110 had selected the advertising content item 508 based on the business name 504 (“Del Piero's”) alone, the advertising content item 508 most likely would not have related to the user's intent in viewing the map 505, since the business name 504 does not include the query of “pizza,” or any similar term.

V. Example Systems for Contextualizing Map Selections

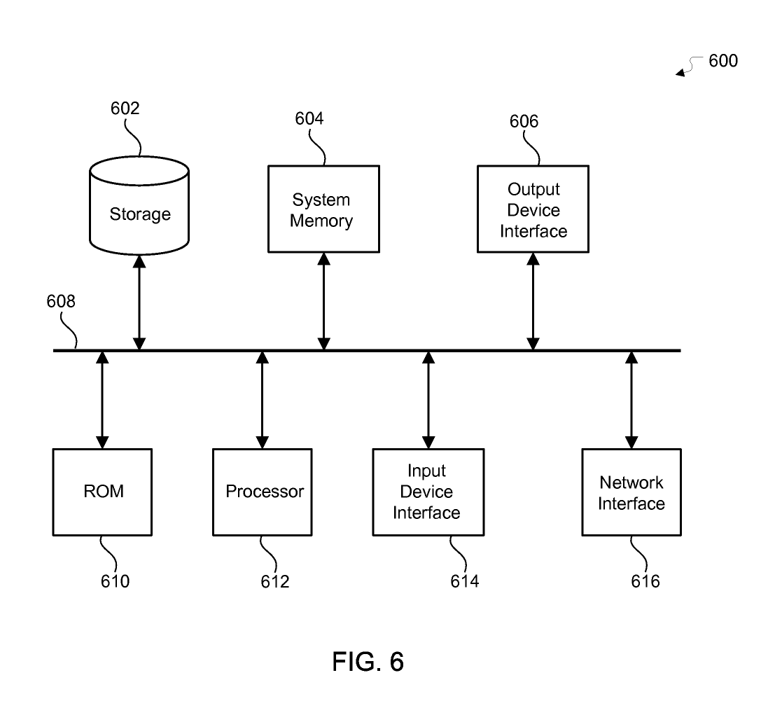

FIG. 6 conceptually illustrates electronic system 600 with which any implementations of the subject technology may be implemented. Electronic system 600, for example, can be a desktop computer, a laptop computer, a tablet computer, a server, a switch, a router, a base station, a receiver, a phone, a personal digital assistant (PDA), or generally any electronic device that transmits signals over a network. Such an electronic system includes various types of computer readable media and interfaces for various other types of computer readable media. Electronic system 600 includes bus 608, processing unit(s) 612, system memory 604, read-only memory (ROM) 610, permanent storage device 602, input device interface 614, output device interface 606, and network interface 616, or subsets and variations thereof.

Bus 608 collectively represents all system, peripheral, and chipset buses that communicatively connect the numerous internal devices of electronic system 600. In one or more implementations, bus 608 communicatively connects processing unit(s) 612 with ROM 610, system memory 604, and permanent storage device 602. From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. One or more implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores any of the instructions and data that processing unit(s) 612 needs at runtime. In one or more implementations, the processes of the subject disclosure are stored in system memory 604, permanent storage device 602, and/or ROM 610. From these various memory units, processing unit(s) 612 retrieves instructions to execute and data to process in order to execute the processes of one or more implementations.

Bus 608 also connects to input and output device interfaces 614 and 606. Input device interface 614 enables a user to communicate information and select commands to the electronic system. Input devices used with input device interface 614 include, for example, alphanumeric keyboards and pointing devices (also called “cursor control devices”). Output device interface 606 enables, for example, the display of images generated by electronic system 600. Output devices used with output device interface 606 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, bus 608 also couples electronic system 600 to a network (not shown) through network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method for contextualizing map selections, the method comprising:
receiving, using one or more computing devices, a query associated with a user;
providing for display, using the one or more computing devices and in response to receiving the query, a map comprising a plurality of objects, each object of the plurality of objects being associated with a business related to the query;
receiving, using the one or more computing devices, a selection of an object of the plurality of objects of the map;
retrieving, using the one or more computing devices and in response to receiving the selection, non-location information related to the business associated with the selected object;
retrieving, using the one or more computing devices, an advertising content item based at least in part on the non-location information related to the business associated with the selected object and the query; and
providing for display, using the one or more computing devices, the advertising content item to a device of the user.

2. (canceled)

3. The method of claim 2, further comprising:
providing for display, using the one or more computing devices, the non-location information related to business associated with the selected object, wherein the non-location information is distinct from the advertising content item.

4. (canceled)

5. (canceled)

6. The method of claim 1, wherein the non-location information corresponds to at least one of a name of the business associated with the selected object, a category related to the business associated with the selected object or a keyword related to the business associated with the selected object.

7. The method of claim 6, wherein retrieving, using the one or more computing devices, the advertising content item based at least in part on the non-location information related to the business associated with the selected object and the query further comprises:
appending, using the one or more computing devices, the query to the name of the business associated with the selected object to generate a second query; and
providing, using the one or more computing devices, the second query to an advertising content retrieval system.

8. The method of claim 1, wherein the receiving the query associated with the user occurs prior to receiving the selection of the object of the plurality of objects of the map.

9. The method of claim 1, wherein the query comprises a map query received from the device of the user.

10. The method of claim 1, wherein the advertising content item comprises at least one of an advertisement, an offer, or a coupon.

11. A computer-implemented method for contextualizing map selections, the method comprising:
receiving, using one or more computing devices, a query associated with a user;
providing for display, using the one or more computing devices and in response to receiving the query, a map comprising a plurality of objects related to the query, wherein the plurality of objects are associated with a plurality of businesses;
receiving, using the one or more computing devices, a selection of an object of the plurality of objects of the map, the selected object being associated with a selected business of the plurality of business;
providing, using the one or more computing devices and to an advertising content retrieval system, the query and at least a portion of non-location information corresponding to the selected business;
receiving, using the one or more computing devices, an advertising content item from the advertising content retrieval system; and
providing for display, using the one or more computing devices, the advertising content item and the non-location information corresponding to the selected business, wherein the advertising content item is distinct from the non-location information.

12. The method of claim 11, wherein the at least the portion of the non-location information comprises at least one of a name of the selected business, a category associated with the selected business, or a keyword associated with the selected business.

13. The method of claim 12, wherein the at least the portion of the non-location information comprises the name of the selected business and wherein providing, using the one or more computing devices and to the advertising content retrieval system, the query and the at least the portion of the non-location information corresponding to the selected business further comprises:
appending, using the one or more computing devices, the query to the name of the selected business to generate a second query; and
providing, using the one or more computing devices and to the advertising content retrieval system, the second query.

14. The method of claim 11, wherein receiving the query associated with the user occurs prior to receiving the selection of the object of the plurality of objects of the map.

15. The method of claim 11, wherein the advertising content item comprises at least one of an advertisement, an offer, or a coupon.

16. A system, comprising:
one or more processors; and
a memory including instructions that, when executed by the one or more processors, cause the one or more processors to:
receive a query associated with a user;
in response to receiving the query, provide for display a map comprising a plurality of objects, each object of the plurality of the objections being associated with a business related to a query;
receive a selection of an object of the plurality of objects of the map;
retrieve non-location information related to the business associated with the selected object;
retrieve an advertising content item based at least in part on the non-location information related to the business associated with the selected object and the query; and
provide for display the advertising content item to a device of the user.

17. (canceled)

18. The system of claim 16, wherein the memory further includes instructions that, when executed by the one or more processors, cause the one or more processors to:
provide for display the non-location information to the device of the user, wherein the advertising content item is distinct from the non-location information.

19. (canceled)

20. The system of claim 16, wherein the non-location information corresponds to a name of the business associated with the selected object, a category related to the business associated with the selected object, or a keyword related to the business associated with the selected object.

21. The system of claim 16, wherein the advertising content item comprises at least one of an advertisement, an offer, or a coupon.

22. A non-transitory machine readable medium embodying instructions that, when executed by a machine, cause the machine to perform a method for contextualizing map selections, the method comprising:
providing a search query corresponding to a map;
receiving for display a plurality of objects on the map based at least in part on the search query, each object of the plurality of objects being associated with a business related to the search query;
providing a selection of an object of the plurality of objects on the map; and
receiving for display non-location information related to the business associated with the selected object; and
receiving for display an advertising content item that is selected based at least in part on the query and at least a portion of the non-location information related to the business associated with the selected object.

23. The non-transitory machine readable medium of claim 22, wherein the at least the portion of the non-location information comprises a name of the business.

24. The non-transitory machine readable medium of claim 22, wherein the advertising content item comprises at least one of an advertisement, an offer, or a coupon.

25. The method of claim 1, wherein the non-location information is exclusive of information related to a geographic location of the business associated with the selected object.
